(19) United States
(12) Patent Application Publication
(10) Pub. No.: US 2008/0107291 A1
(43) Pub. Date: May 8, 2008

(54) Omni directional adjustable acoustic lens

(76) Inventor: David W. Livingston, Polo, IL (US)

Correspondence Address: David W Livingston Jr., 102 W Elkhorn St., Polo, IL, 61064, US

(21) Appl. No.: 11/584,440

(22) Filed: Oct. 23, 2006

(51) Int. Cl. H04R 25/00

(52) U.S. Cl. 381/152; 381/150

(57) ABSTRACT

An omni directional adjustable acoustic lens is a means to adjust the Hertz range of sound So it can be acoustically set. Then the lens projects the sound in a 360 degree fashion.

### FIELD OF INVENTION

This invention relates to the dispersion of sound. This lens allows the user to adjust different ranges of sound from a desired speaker.

### SUMMARY OF INVENTION

This invention is done with a number of discs, with different sized holes in each disc. The discs are spaced a distance apart so that each layer of discs will catch a different range of sound. By the blocking of different spaces in-between the layers of discs, you can choose the range of sound you want to use. It then projects the sound, Omni directional (360 degrees).

### BRIEF DESCRIPTION OF THE DRAWINGS

FIG. 1 is a side view of the invention with arrows 1A through arrows 1E. It refers to claims 1 through 11.

FIG. 2 is the bottom view that shows the shape and size of the wholes in FIG. 1. It also shows the shape and of the discs.

FIG. 3 is also a side view with added drawings that the DETAILED DESCRIPTION refers to.

### DETAILED DESCRIPTION

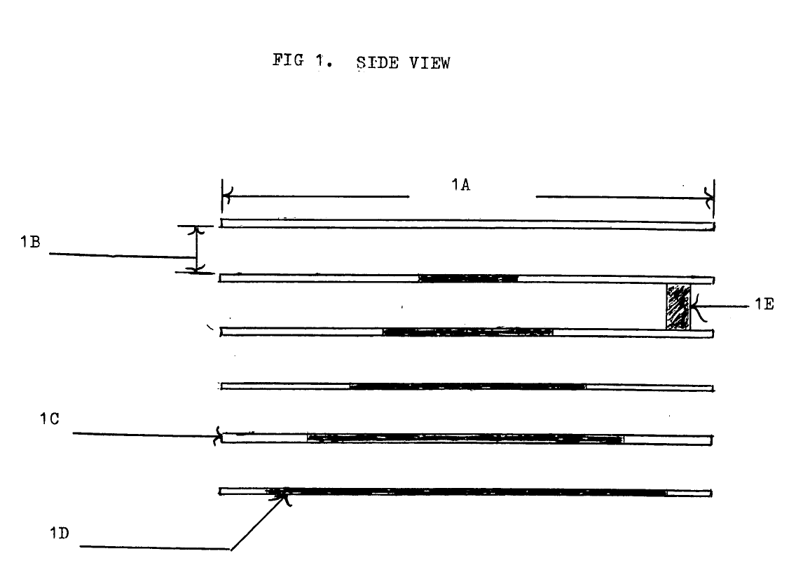

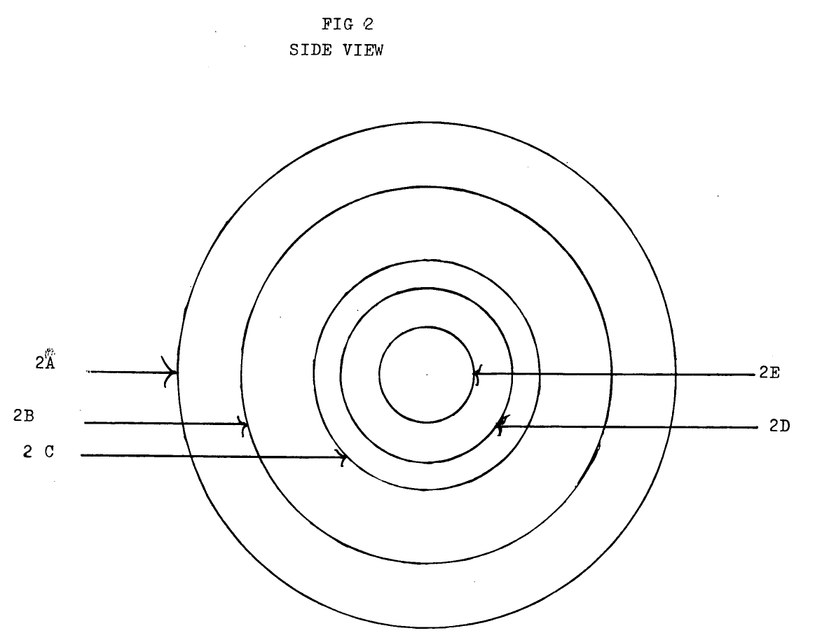

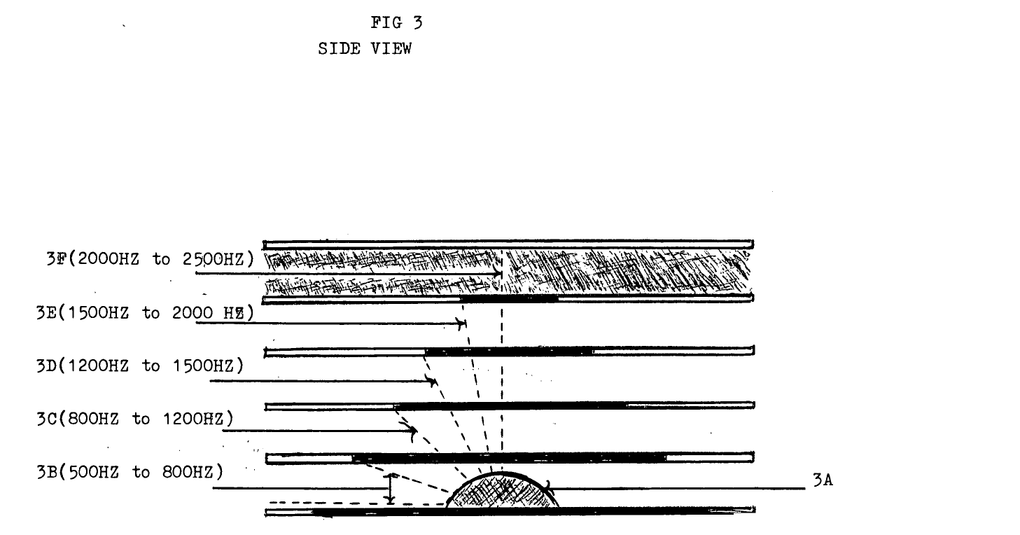

This invention is done with air space between multiple layers of discs. The discs in each layer will have a different sized port hole; this is shown in FIG. 1 arrow 1D. Arrow 1D is a shaded area in the disc that gives the size of the port hole in the disc, as does all shaded areas in FIG. 1. As each port hole in each disc gets smaller, as seen in FIG. 2; arrows 2A through 2E. They then will collect a different range of sound as seen in FIG. 3; arrows 3B through 3F, arrows 3B through arrows 3F are dotted lines that show different port holes collecting the different ranges of sound that arrow 3A is dispersing. FIG. 3 arrow 3F is also showing a shaded area that is representing a blocked off area, which is a range of sound not being used. By using a mid-range speaker in one lens and a high-range speaker in another lens, then blocking off the proper spaces in each lens, can give the ability to take out any over lapping ranges of sound between the two lenses (being acoustic set). This lens can be used for many applications; address systems, speaker systems, concert hall systems. Any one in the Arts of this Field will understand how this lens works.

What is claimed is:

1. Omni Directional Adjustable Acoustic Lens comprising, (a) any number of discs, (b) any size whole in the discs, (c) any distance in-between the discs. (Refers to FIG. 1).

2. Defined in claim 1(a-c); Can be used with any full-range, any midrange, any high-range or any low-range speaker. (Refers to FIG. 3, arrow 3A).

3. Defined in claim 2; Can be used with any style of speaker, for example; soft dome speaker, paper speaker, solid state speaker. (Refers to FIG. 3, arrow 3A).

4. Defined in claim 1(a); Can be made of any man-made or natural materials, examples; wood, ceramic, plastic, steel. (refers to FIG. 1).

5. Defined in claim 1(a & b); Can be any shape, example; disc, square, bowl, flat, curved or pyramid. (Refers to FIG. 1, arrows 1A and 1D).

6. Defined in claim 5; Can have shapes that are made in sizes from 1/100 inch to 100,000 inches. (Refers to FIG. 1, arrows 1A and 1D).

7. Defined in claim 1(b); Can have a whole size from 1/99 inches to 99,999 inches. (Refers to FIG. 1, arrow 1D).

8. Defined in claim 1(b); Can have any shaped whole in the discs, example; oval, circular, square, triangle. (Refers to FIG. 1 arrow 1D).

9. Defined in claim 1(c); Can be the distance of 1/100,000 inches to 1,000 inches. (Refers to FIG. 1 arrow 1B).

10. Defined in claim 1(a) the disc can have a thickness of; 1/1,000 inch to 1,000 inches. (Refers to FIG. 1 arrow 1C).

11. Defined in claim 1; Can have spacers made of any man-made or natural material example; wood, plastic, magnets. (Refers to FIG. 1 arrow 1E).
